(19) United States
(12) Patent Application Publication
(10) Pub. No.: US 2022/0404677 A1
(43) Pub. Date: Dec. 22, 2022

(54) BUILDING CLADDING SYSTEMS COMPRISING SWITCHABLE MATERIALS AND METHODS OF USE THEREOF

(71) Applicant: Westlake Royal Building Products Inc., Houston, TX (US)

(72) Inventors: Amitabha KUMAR, San Antonio, TX (US); Andrew B. METZGER, San Antonio, TX (US)

(73) Assignee: Westlake Royal Building Products Inc., Houston, TX (US)

(21) Appl. No.: 17/842,240

(22) Filed: Jun. 16, 2022

Related U.S. Application Data
(60) Provisional application No. 63/211,798, filed on Jun. 17, 2021.

(51) Int. Cl. G02F 1/163; G02F 1/01; G02F 1/1524; G02F 1/1503; E04F 13/08

(52) U.S. Cl. CPC G02F 1/163; G02F 1/0147; G02F 1/0126; G02F 1/1524; G02F 1/1503; E04F 13/0871

(57) ABSTRACT

Building cladding systems with changeable appearances and methods of use are described. The building cladding system may include a substrate and a coating comprising a switchable material. Varying a voltage, temperature, or wavelength of light on or applied to the coating may change an appearance of the building cladding system.

### CROSS-REFERENCE TO RELATED APPLICATION(S)

This application claims priority to U.S. Provisional Application No. 63/211,798 filed on Jun. 17, 2021, which is incorporated by reference herein in its entirety.

### TECHNICAL FIELD

The present disclosure generally relates to building cladding systems with changeable appearances, and methods of use thereof.

### BACKGROUND

Different building cladding may be used to change the external appearance of commercial or residential buildings. Exterior surfaces of the cladding are generally prepared with the desired aesthetic design, such as with paint or other additions or decoration to provide the desired design. The finished cladding surface on the building is permanent and the appearance of the building, or a portion of the building, can only be altered with significant effort and cost to replace the design. For instance, traditional means of altering the appearance of building cladding involve re-finishing or removing existing cladding.

### SUMMARY

The present disclosure includes building cladding systems which may comprise a substrate or a plurality of substrates and at least one coating on each substrate. The substrate may comprise wood, concrete, cement, or a polymer, for example. In some examples, the coating may comprise a switchable material. Varying a voltage or a temperature on the coating may change an appearance of the building cladding system, such as by changing light absorption by the coating. According to some aspects of the present disclosure, the coating comprises a conductive material. For example, the conductive material may comprise copper, indium, tin, or a combination thereof.

In some embodiments, the switchable material may be an electrochromic material, a photochromic material, a thermochromic material, or a combination thereof. In at least one example, the switchable material may comprise an electrochromic material. For example, the electrochromic material may comprise a metal (including, for example, a transition metal), a metal alloy (including, for example, a transition metal alloy), or a viologen. An exemplary metal or metal alloy may comprise tungsten, a tungsten alloy, molybdenum, a molybdenum alloy, iridium, an iridium alloy, vanadium, a vanadium alloy, nickel, a nickel alloy, or a combination thereof. In some examples wherein the electrochromic material comprises a viologen, the viologen may be methyl viologen, ethyl viologen, heptyl viologen, a polyviologen, a viologen-functionalized conjugated polymer, or a combination thereof. In at least one example, the coating comprises a conductive material that forms a first layer of the coating and the switchable material (such as an electrochromic material) may form a second layer of the coating.

In some examples, the coating may further comprise a primer layer, the primer layer being adjacent to the substrate. Additionally or alternatively the coating may further comprise a non-conducting layer that forms an outermost layer of the coating. The non-conducting layer may be transparent or translucent.

According to some aspects of the present disclosure, the system may further comprise a controller. The controller may be configured to vary a voltage, temperature, or wavelength of light applied to the coating. In some examples, the controller may comprise an actuator. The actuator may be configured to vary the voltage, temperature, or wavelength of light by mechanical user input. In other examples, the controller may comprise a microprocessor. The microprocessor may be configured to receive user input wirelessly and vary the voltage, temperature, or wavelength of light applied to the coating based on the user input.

Also disclosed herein are methods of using the building cladding system as discussed above and elsewhere herein to change the appearance of the building cladding system. For example, a method of changing an appearance of the building cladding system as discussed above may comprise applying a voltage, temperature, or wavelength of light to the coating, wherein the coating absorbs a first wavelength of light. The method may also comprise changing the voltage, temperature, or wavelength of light, wherein the coating absorbs a second wavelength of light different than the first wavelength of light. In some examples, each of the first wavelength of light and the second wavelength of light may be between 380 nm and 760 nm.

In some aspects of the present disclosure, the building cladding system used in the method as discussed above may comprise a controller configured to change the voltage, temperature, or wavelength of light. The controller may comprise a microprocessor and changing the voltage, temperature, or wavelength of light with the controller may include receiving user input wirelessly by the microprocessor. In some examples, the controller may further comprise a sensor and the microprocessor may be configured to change the voltage, temperature, or wavelength of light applied to the coating based on a parameter detected by the sensor. For example, the parameter detected by the sensor may be light (such as ambient light), temperature, or moisture.

In at least one example, the method as discussed above may further comprise applying a different voltage to the coating after the voltage, temperature, or wavelength of light is changed. The coating may absorb a third wavelength of light different than the first and second wavelength of light. The third wavelength of light may be between 380 nm and 760 nm. The voltage, temperature or wavelength of light applied to the coating after the voltage, temperature, or wavelength of light is changed may be applied with a controller.

The present disclosure also includes a method of changing an appearance of building cladding, the method comprising applying a voltage, temperature, or wavelength of light to a visible surface of the building cladding and changing the voltage, temperature, or wavelength of light. The visible surface of the building cladding may comprise a coating and the coating may comprise a switchable material, such as an electrochromic material, thermochromic material, photochromic material, or combination thereof. In some examples, the appearance of building cladding includes a color of the building cladding. In at least some examples herein, applying and changing the voltage, temperature, or wavelength of light to the visible surface of the building cladding may change the color of the building cladding.

### BRIEF DESCRIPTION OF THE DRAWINGS

The accompanying drawings, which are incorporated in and constitute a part of this application, illustrate certain exemplary features of the present disclosure, and together with the description, serve to explain the principles of the present disclosure. Elements depicted in the figures are not necessarily drawn to scale. The dimensions of some features may be exaggerated relative to other features to improve understanding of exemplary embodiments. Those of ordinary skill in the art will readily recognize that the features of a particular aspect or embodiment may be used in conjunction with the features of any or all of the other aspects or embodiments described in this disclosure.

FIG. 1 illustrates an exemplary building cladding system according to some aspects of the present disclosure.

FIG. 2 illustrates an exemplary building cladding system according to some aspects of the present disclosure.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±5% of a specified amount or value. All ranges are understood to include endpoints, for example a range between 380 nm and 760 nm includes 380 nm, 760 nm, and all values between.

The present disclosure generally includes building cladding systems. For example, the building cladding system may include a substrate and a coating. The substrate may comprise a natural material, synthetic material, or both. Exemplary substrates suitable for the present disclosure include, but are not limited to, wood, cement, concrete, metal, and polymers (including polymer composites). In some examples, the substrate comprises a polymer composite that comprises an inorganic filler. For example, the polymer may comprise polyurethane, optionally a polyurethane composite.

The coating may be configured to change the appearance of the building cladding system. The appearance of the building cladding system may be changed in a reversible and controlled manner. For example, the coating may comprise a switchable material capable of changing appearance by exposure to a parameter, such as an external influence. The external influence may include an external stimulus such as ion(s), phonon(s) or photon(s), or the application of an electric field, heat, or light. According to some aspects of the present disclosure, an electric field may be induced by the application of voltage. The switchable material of the present disclosure may comprise an electrochromic material, thermochromic material, photochromic material, or a combination thereof.

For example, the coating may comprise an electrochromic material, wherein the application of voltage may induce an electric field that causes a change in light absorption by the electrochromic material. As such, applying and varying a voltage to the coating may change light absorption by the coating. Exemplary electrochromic materials suitable for the present disclosure may be organic or inorganic. Exemplary electrochromic materials include, but are not limited to, metals, metal alloys, metal oxides, and viologens. In some examples, the electrochromic material comprises a transition metal a transition metal oxide, or both. For example, the electrochromic material may comprise tungsten, molybdenum, iridium, vanadium, nickel, oxides thereof, or combinations thereof. Further, for example, the electrochromic material may comprise a viologen, which is an organic compound comprising conjugated bi-/multi-pyridyl groups, with the formula (C5H4NR)₂ⁿ⁺ (N,N′ di-quaternized bipyridyl salt). Exemplary viologens suitable for the present disclosure include, but are not limited to, methyl viologen, ethyl viologen, heptyl viologen, a polyviologen, a viologen-functionalized conjugated polymer, or a combination thereof. According to some examples herein, the electrochromic material comprises a transition metal oxide. For example, the electrochromic material may comprise tungsten dioxide (WO₂), molybdenum trioxide (MoO₃), iridium (VI) oxide (IrO₂), nickel oxide (NiO), vanadium (V) oxide (V₂O₅), or a combination thereof

The electrochromic material may absorb visible light, a wavelength between 380 nm and 760 nm. In some examples, the appearance of the building cladding includes a color of the building cladding. The steps of applying voltage changing the voltage, or both applying the voltage and changing the voltage applied to the coating may change the color of the building cladding. In at least one example, the electrochromic material changes from blue to violet upon application of 1 V per micrometer of thickness of electrochromic material.

Changing the voltage applied to the coating may change the absorption properties of the coating, depending on the nature of the electrochromic material. For example, the coating may absorb a first wavelength of light when a first voltage is applied, and a second wavelength of light different than the first wavelength of light when a second voltage is applied. The second wavelength may be less than or greater than the first wavelength of light.

A voltage applied to an electrochromic material may induce an oxidation-reduction reaction. The voltage may range from about 0.5 V to about 5.5 V, such as about 1 V to about 5 V, about 1 V to about 3 V, about 2.5 V to about 4.5 V, about 3 V to about 5 V, or about 3.5 V to about 5.5 V. The oxidation-reduction reaction allows for a generation of different visible region electronic absorption bands upon switching between redox states, which results in a visible change in transmittance of color, reflectance of color, or both. An application of a voltage and a change in the voltage applied allows for a change in the wavelength of visible light that is absorbed and the color that is reflected.

As mentioned above, the coating may comprise a thermochromic material. Varying the temperature of a coating (including by the application of heat cooling, or both) that comprise one or more thermochromic materials may change the appearance (such as color) of the coating and building cladding system. In at least one example, the color of the coating and building cladding system may be changed by varying the temperature of a coating comprising one or more thermochromic materials. Thermochromic materials include liquid crystal materials that can change phase, for example revert between smectic and nematic phases, depending on the temperature. A layer with a thermochromic material in the smectic phase arrangement is believed to be one in which molecular layers slide past one another, the material appearing almost transparent to light by allowing most of the light to transmit through the layer. The same layer, upon being heated to temperatures above the clearing point, for example, may have an isotropic molecular arrangement with the same optical properties in all directions, known as the nematic state, again appearing transparent. Such a layer may have a color when the layer s between temperatures where the material is entirely in the smectic or nematic state. Thus a material may appear transparent when cold, may have a color when hot, and then transparent when hotter, Thus, for example, heating or cooling the thermochromic material may alter the phase of the material, in turn changing the wavelength of light absorbed, reflected, or both. Other suitable thermochromic materials for the systems herein include leuco dyes. Leuco dyes are organic materials that have a colored (“leuco”) form and a non-colored (“non-leuco”) form, such as depending on temperature, providing for a difference in absorption of light. The colored and non-colored form of leuco dyes may depend on temperature. For example, the application of heat cooling, or both may allow for conversion between one form and another. According to some examples, the coating may comprise a mixtures of leuco dyes to provide changes in color at different temperatures. Exemplary leuco dyes include, but are not limited to, the sipro form of oxazine and crystal violet lactone.

As also mentioned above, the coating may comprise a photochromic material. Varying the wavelength of light applied to a coating comprising a photochromic material may change the color of the coating and appearance of the building cladding system. Photochromic behavior is believed to result from reversible transformation of a particular chemical species through the absorption of electromagnetic radiation (photoisomerization). Different forms of photochromic materials may have different optical absorption properties, resulting in different appearance(s). The different appearances may generally range from transparent to different colors, or darkening of a color. For example, a photochromic material may be dispersed in an optical glass medium wherein the glass darkens upon exposure to light. The change in color may be reversible, and may switch back and forth between different appearances as a function of the incident light intensity. Photochromic materials include inorganic materials and organic polymers that exhibit photoisomerization. Exemplary photochromic materials include, but are not limited to, silver halides, zinc halides, quinones, azobenzenes, sipropyrans, and combinations thereof.

The coating may also include a conductive material. For example, when the coating comprises an electrochromic material, the coating may comprise a conductive material that completes the circuit when voltage is applied. Exemplary conductive materials suitable for the present disclosure include, but are not limited to, copper, indium, tin, and combinations thereof. For example, a conductive material may include indium tin oxide (ITO). In some examples, the coating may be adjacent to the substrate, such as between the substrate and the electrochromic material. For example, the conductive material may form a first layer and the electrochromic material may form a second layer. In some examples, a relatively thin, uniform, or both thin and uniform, layer of the conductive material may be applied over the substrate, and one or more layers of electrochromic material(s) may be applied over the conductive material layer. For example, the conductive material may be applied to the substrate by vapor deposition coating. In some aspects of the present disclosure, the conductive material layer may have a thickness of at least 20 μm or less than 150 μm. For example, the conductive material may have a thickness of 20 μm to 150 μm, 25 μm to 50 μm, 50 μm to 100 μm, 35 μm to 105 μm, 75 μm to 125 μm, or 55 μm to 75 μm.

Optionally, the coating may further include a primer layer. A primer layer may be beneficial when the substrate is nonconductive. The primer layer may have a thickness of at least 10 μm, less than 5 mm, or at least 10 μm and less than 5 mm, such as 1 mm to 3 mm, 25 μm to 1 mm, 0.5 mm to 2.5 mm, 25 μm to 75 μm, or 125 μm to 0.5 mm. The primer layer facilitate adhesion of the coating with the substrate. For example, the primer layer may be adjacent to the substrate, such as between the substrate and the conductive material or between the substrate and the conductive material. Exemplary materials suitable for the non-conducting layer include, but are not limited to, a metal grid, a random metal network such as a non-woven mesh, a metal film or paint with conductive properties, graphene, carbon (including carbon nanotubes), nanowire meshes, ultra thin metal films, conductive pigment, or nickel metal. In at least one example, the primer layer comprises indium tin oxide.

According to some aspects of the present disclosure the coating further comprises a non-conducting layer that forms the outermost layer of the coating. The non-conducting layer may be transparent or translucent. Exemplary materials suitable for the non-conducting layer include, but are not limited to, acrylics. Optionally, the non-conducting layer may be a UV stabilized transponder acrylic.

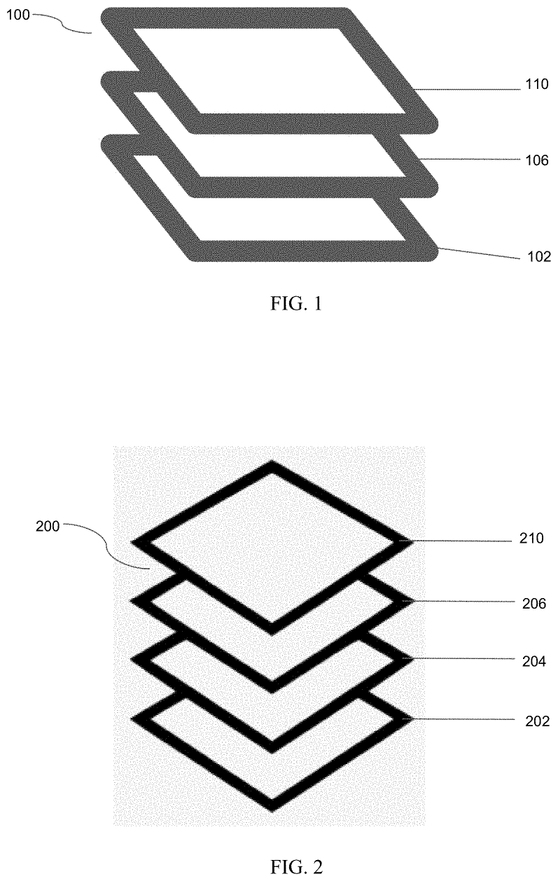

FIG. 1 illustrates features of an exemplary building cladding system 100. Building cladding system 100 includes substrate 102 and a coating comprising first and second layers 106, 110. For example, first layer 106 may comprise a conductive material, and second layer 110 may comprise an electrochromic material.

FIG. 2 illustrates features of another exemplary building cladding system 200. Building cladding system 200 includes substrate 202, a primer layer 204, and first and second coating layers 206, 210. Primer layer 204 is adjacent to substrate 202. Layers 206 and 210 are applied over primer layer 204. For example, first layer 206 may comprise a conductive material, and second layer 210 may comprise an electrochromic material.

The building cladding system may comprise a controller configured to vary a voltage applied to the coating. The controller may operate mechanically, electronically, or a combination thereof. For example, the controller may include an actuator configured to vary the voltage by mechanical user input. Such actuators may include, such as a switch, dial, button, or other actuator. In other examples, the controller may comprise a microprocessor configured to vary the voltage applied to the coating based on wireless user input. For example, the microprocessor may receive user input wirelessly and transfer the user input into a change of voltage applied to the coating. In such cases, the controller may include suitable electronic components such as an integrated circuit, memory, transmitter, or combination thereof suitable for receiving user input and initiating instructions according to an algorithm stored in the controller. The controller may include a printed circuit board to support and electrically connect such components.

According to some aspects of the present disclosure, the controller may also comprise or otherwise be in communication with a sensor configured to detect a parameter such as light, temperature, moisture, or a combination thereof. In such cases, the controller may change the voltage applied to the coating based on a parameter detected by the sensor, for example wherein data collected by the sensor is transmitted to the microprocessor of the controller for initiating a suitable algorithm stored in the controller. For example, the building cladding system may be configured to change appearance in response to a change in environmental status such as the time of day, the time of year, the amount of light, the weather condition, the climate, etc. The ability to change voltage via data collected by the sensor may be automatic. For example, the building cladding system may be configured such that the controller changes the voltage by a predetermined amount when the sensor detects a parameter that exceeds or falls below a predetermined threshold.

In some examples herein, a thermo-sensing device may be used to detect or measure temperature by generating a current, which may be used to modulate voltage applied to an electrochromic material present in the coating. Examples of thermo-sensing devices include thermocouples and thermopiles. Such thermo-sensing devices may be suitable for measuring temperatures that are generally within the range of ambient atmosphere (for example −50° C. to 50° C.). In some aspects, thermo-sensing devices with a wider measurement range may be used. For example, a thermo-sensing device with a wider temperature measurement range may be used to illustrate or amplify temperatures around a cooling area, a reactor, a furnace, or a kiln. In such cases, the temperature may range, for example, from −150° C. to 2000° C. In these examples, the temperature ranges may correspond to a given color of the thermochromic material.

In some examples, the sensor may be a humidity sensor that measures moisture. A solid state humidity sensor, such as a porous ceramic dielectric, may be suitable for such measurements, usually between 10% and 90% relative humidity. The information from the humidity sensor may be used to modulate the voltage to the electrochromic layer to control and alter the appearance, including color(s), design(s), or a combination thereof, of the coating of the building cladding system.

Further, for example, the sensor may detect light. In some examples, the sensor is a photoelectric device. Such sensors may be programmed to determine the onset of dawn dusk or dawn and dusk, or other variations in ambient light. The variation in ambient light detected by the sensor may, in-turn be used to control and modulate the appearance of the coating comprising an electrochromic material. For example, the sensor detected variation in ambient light may be used to change the color, design, or other aspects of the appearance of the building cladding system as desired by the user.

In an exemplary method, a first voltage is applied to a coating of a building cladding system, wherein the coating comprises an electrochromic material, and the coating absorb a first wavelength of light between 380 nm and 760 nm. For example, the coating may absorb a first wavelength of about 550 nm so that the building cladding system appears purple. Next, the voltage may be changed so that the coating absorbs a second wavelength of about 520 nm and the building cladding system appears red. By varying the voltage applied to the coating of the building cladding, the color, appearance, or both color and appearance of the building cladding can be changed as often as desired.

Systems and methods described herein provide methods for modifying the appearance of a building, a portion of a building, building cladding, or other feature of the building. While most building materials, systems, and methods described herein relate to modifying the appearance of an exterior (for example an exterior portion of a building or an exterior surface of building cladding), the materials, systems, and methods may also relate to modifying the appearance of an interior, which includes an interior portion of a building.

The building cladding systems of the present disclosure may be manufactured by suitable processes, including processes for preparing a substrate and depositing layers on a substrate. Exemplary processes for preparing the substrate include, but are not limited to, cutting (including making/shaping planks of wood or wood like materials), extrusion, sheeting forming, bending, and forming shapes.

In some aspects of the present disclosure, conductive materials (when present), switchable materials, or both conductive materials and switchable materials may be applied to a substrate by a suitable technique such as chemical vapor deposition (CVD), for example, to form layers. In other examples, the substrate may be painted with conductive material (when present), switchable material(s), or both, for example to form layers. Such painting may be conducted by pouring, a waterfall technique, or using rollers, brushes, sprays, or a combination thereof. In some examples, one or more surfaces of a substrate may be prepared for the application of conductive materials, switchable materials, or both conductive materials and switchable materials. For example, a primer layer may be applied to a substrate via CVD, painting, or other application techniques so as to render the surface(s) suitable for application of conductive materials, switchable materials, or both. Suitable preparation processes for primer layers include, but are not limited to, brushing, etching, sanding, abrasion, and erosion.

In some examples, the conductive material (when present), switchable material(s), or both the conductive material and switchable material(s) may adhered to the substrate. For example, a glue or other adhesive may be used to fixedly secure the coating to the substrate. In these examples, the conductive material (when present) or switchable material(s) or both may be in the form of films. In at least one example, a film of conductive material, a film of switchable material, or both, may be fused to the substrate. Exemplary fusion processes include the use of heat, light, moisture, glue or other adhesive, or drying.

While principles of the present disclosure are described herein with reference to illustrative aspects for particular applications, the disclosure is not limited thereto. Those having ordinary skill in the art and access to the teachings provided herein will recognize additional modifications, applications, aspects, and substitution of equivalents that all fall in the scope of the aspects described herein. Accordingly, the present disclosure is not to be considered as limited by the foregoing description.

What is claimed is:

1. A building cladding system comprising:
a substrate comprising wood, cement, or a polymer; and
a coating on the substrate, the coating comprising a switchable material:
wherein varying a voltage or a temperature on the coating changes an appearance of the building cladding system by changing light absorption by the coating.

2. The system of claim 1, wherein the coating further comprises a conductive material.

3. The system of claim 1, wherein the switchable material comprises an electrochromic material, a photochromic material, a thermochromic material, or a combination thereof.

4. The system of claim 3, wherein the switchable material comprises an electrochromic material, and the electrochromic material comprises a metal, a metal alloy, or a viologen.

5. The system of claim 4, wherein the metal or metal alloy comprises tungsten, a tungsten alloy, molybdenum, a molybdenum alloy, iridium, an iridium alloy, vanadium, a vanadium alloy, nickel, a nickel alloy, or a combination thereof.

6. The system of claim 4, wherein the electrochromic material comprises a viologen, and the viologen is methyl viologen, ethyl viologen, heptyl viologen, a polyviologen, a viologen-functionalized conjugated polymer, or a combination thereof.

7. The system of claim 1, wherein the coating comprises a conductive material that forms a first layer of the coating, and wherein the switchable material forms a second layer of the coating.

8. The system of claim 1, wherein the coating further comprises a primer layer, the primer layer being adjacent to the substrate.

9. The system of claim 1, wherein the coating further comprises a non-conducting layer that forms an outermost layer of the coating, the non-conducting layer being transparent or translucent.

10. The system of claim 1, further comprising a controller configured to vary a voltage, temperature, or wavelength of light applied to the coating.

11. The system of claim 10, wherein the controller comprises an actuator configured to vary the voltage, temperature, or wavelength of light by mechanical user input.

12. The system of claim 10, wherein the controller comprises a microprocessor configured to receive user input wirelessly and vary the voltage, temperature, or wavelength of light applied to the coating based on the user input.

13. The system of claim 1, wherein the coating comprises:
a primer layer adjacent the substrate;
a first layer comprising a conductive material;
a second layer comprising the switchable material, wherein the switchable material comprises an electrochromic material; and
a non-conducting layer that is transparent or translucent.

14. A method of changing the appearance of the building cladding system of claim 1, the method comprising:
applying a voltage to the coating, wherein the coating absorbs a first wavelength of light; and
changing the voltage, wherein the coating absorbs a second wavelength of light different than the first wavelength of light.

15. The method of claim 14, wherein each of the first wavelength of light and the second wavelength of light is between 380 nm and 760 nm.

16. The method of claim 14, wherein the system further comprises a controller configured to change the voltage, wherein the controller comprises a microprocessor, and wherein changing the voltage with the controller includes receiving user input wirelessly by the microprocessor.

17. The method of claim 14, wherein the controller further comprises a sensor, the microprocessor being configured to change the voltage applied to the coating based on a parameter detected by the sensor.

18. The method of claim 17, wherein the parameter detected by the sensor is light, temperature, or moisture.

19. A method of changing an appearance of building cladding, the building cladding comprising a coating that comprises a conductive material and an electrochromic material, the method comprising:
applying a voltage to the building cladding, wherein the coating absorbs a first wavelength of visible light; and
changing the voltage with a controller comprising a microprocessor and a sensor by receiving user input wirelessly by the microsensor, wherein the microprocessor changes the voltage based on a parameter detected by the sensor, and wherein changing the voltage causes the coating to absorb a second wavelength of visible light different from the first wavelength of visible light;
wherein the coating forms an outermost surface of the building cladding.

20. The method of claim 19, wherein the parameter is light, temperature, or moisture.
